(19) United States
(12) Patent Application Publication
(10) Pub. No.: US 2013/0088414 A1
(43) Pub. Date: Apr. 11, 2013

(54) SURGICAL HEADS-UP DISPLAY THAT IS ADJUSTABLE IN A THREE-DIMENSIONAL FIELD OF VIEW

(71) Applicants: Alexander N. Artsyukhovich, Irvine, CA (US); Mikhail Boukhny, Laguna Niguel, CA (US)

(72) Inventors: Alexander N. Artsyukhovich, Irvine, CA (US); Mikhail Boukhny, Laguna Niguel, CA (US)

(21) Appl. No.: 13/615,937

(22) Filed: Sep. 14, 2012

Related U.S. Application Data
(60) Provisional application No. 61/543,582, filed on Oct. 5, 2011.

(51) Int. Cl. G09G 5/00

(52) U.S. Cl. 345/7

(57) ABSTRACT

An ophthalmic surgical system includes a three-dimensional imaging device operable to display a three-dimensional image of a patient's eye. The ophthalmic surgical system further includes a display device including an image processor The display device is operable to generate a heads-up display of user-selectable surgical parameters on the three-dimensional image of the patient's eye. The heads-up display is adjustable in a three-dimensional field of view of the three-dimensional image. The system also includes a user interface operable to receive a user selection of one or more of the user-selectable surgical parameters to be displayed.

### RELATED APPLICATIONS

This application claims priority to U.S. provisional application Ser. No. 61/543,582, filed on Oct. 5, 2011, the contents which are incorporated herein by reference.

### TECHNICAL FIELD

This application relates to ophthalmic surgical devices and, more particularly, to a heads-up overlay for a 3-D ophthalmic surgical viewer.

### BACKGROUND

Various displays have been provided for ophthalmic surgical consoles. Such displays may frequently be overlaid on the surgical microscope used to view the eye. However, ophthalmic surgical microscopes have certain drawbacks. For example, the surgeon must keep his head in a relatively fixed position while performing surgery. In another example, the use of an assistant scope requires division of light energy between multiple beam paths. This may require additional illumination to produce sufficiently bright images, and the intense illumination may have phototoxic effects on ocular tissue.

Digital imaging has been used more frequently in ophthalmic surgical applications, including diagnostics as well as surgical visualization. One advantage of such systems is that they can provide three-dimensional viewing of the eye. However, such systems lack many of the tools and features useful for ophthalmic surgeons. Hence, there remains a need for a solution that avoids the drawback of ophthalmic surgical microscopes while still providing desirable features.

### SUMMARY

In accordance with a first aspect of the disclosure, an ophthalmic surgical system includes a three-dimensional imaging device operable to display a three-dimensional image of a patient's eye. The ophthalmic surgical system further includes a display device including an image processor The display device is operable to generate a heads-up display of user-selectable surgical parameters on the three-dimensional image of the patient's eye. The heads-up display is adjustable in a three-dimensional field of view of the three-dimensional image. The system also includes a user interface operable to receive a user selection of one or more of the user-selectable surgical parameters to be displayed.

In accordance with another aspect of the disclosure, a method of generating a heads-up display for an ophthalmic surgical system includes receiving a selection of at least one surgical parameter to be displayed. The method further includes determining a location of a heads-up display in a three-dimensional view of a three-dimensional image of a patient's eye. The location of the heads-up display in the three-dimensional view is adjustable based on at least one user selection. The method also includes displaying the heads-up display in the three-dimensional image of the patient's eye.

Additional aspects, features, and advantages of various embodiments of the present invention will be apparent to one skilled in the art from the following description.

### DESCRIPTION OF FIGURES

FIG. 1 is a block diagram of an ophthalmic surgical system 100 according to a particular embodiment of the present invention; and

FIG. 2 is an example method for adjustment of a heads-up display in a three-dimensional view according to another embodiment of the present invention.

### DETAILED DESCRIPTION

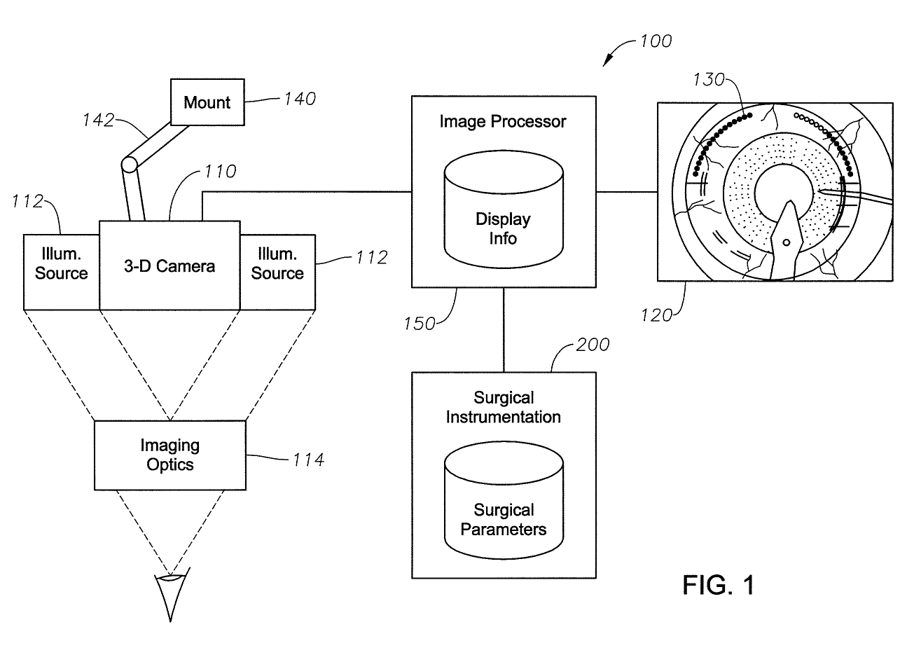

FIG. 1 illustrates an ophthalmic surgical system 100 according to a particular embodiment of the present invention. The system 100 includes a 3-D camera 110 with at least one illumination source 112 and imaging optics 114, a display screen 120 for displaying 3-D images recorded by the camera with a heads-up display 130 overlaid on the 3-D image, and a mount 140, which includes an articulating arm 142 in the depicted embodiment. The 3-D camera 110 may include any suitable imaging device, such as a CCD camera, for capturing a digital image for presentation in a three-dimensional view. The illumination source 112 may be any suitable form of illumination, such as a xenon arc lamp, a white laser illuminator, or any number of illumination sources used in microscopy. The imaging optics 114 include any optical element or collection of elements for transmitting light from the patient's eye to the 3-D camera 110 and preferably for transmitting illuminating light to the patient's eye. The imaging optics 114 may also include one or more elements placed on the patient's eye to allow visualization of ocular structures.

The display screen 120 may be any suitable display for three-dimensional images, which may be remote from the surgical system and may be connected physically or wirelessly. The display screen 120 may be one that is viewable with compatible 3-D glasses, or it could be a system where glasses are not required. Fixed-angle 3-D views that do not require glasses may be particularly suitable for surgical systems, in that the surgeon tends to look at the display screen 120 from one position at a specific angle.

The system 100 also includes an image processor 150, which represents any suitable combination of one or more information-processing devices, including but not limited to microprocessors, microcontrollers, or ASICs, along with any compatible form of volatile or non-volatile information storages, which may include but is not limited to optical, semiconductor and/or magnetic media. The system 100 may include one or more diagnostic devices 160. Diagnostic devices 160 may include, for example, keratometers, optical coherence tomography (OCT) equipment, Hartmann-Shack wavefront sensors, or numerous other instruments for measuring properties of an eye. In certain embodiments, diagnostic devices 160 will be part of the surgical system 100. In other embodiments, the system 100 may be configured to receive information from diagnostic devices that can be used to generate the overlaid display 130 for the system. Likewise, the display 130 can be aligned with the image of the eye using such information. For example, the image of the eye can be registered to a pre-operative image of the eye, providing a reference for the surgical display.

The 3-D image can also be registered to provide depth information using such diagnostic information. For example, if OCT measurements have been taken of the eye, such as anterior chamber depth measurements, then the depth information can be registered to common anatomical features in the image from the 3-D camera to reconstruct a 3-D view for the surgeon. Also, through feature recognition and digital image enhancement techniques, the quality of the image (sharpness, color, contrast, edge visibility) can be improved, and important features, such as retinal vessels or membranes, can be highlighted in the image. Similarly, the image can be augmented with false color displays or other suitable techniques for visualizing wavelengths detectable by diagnostic devices 160 that would be invisible to the surgeon, including infrared and/or ultraviolet wavelengths.

The system 100 further includes ophthalmic surgical instrumentation 200 such as a phacoemulsification console, a laser refractive or laser cataract surgical console, a vitreoretinal surgical console, or any other suitable device for performing ophthalmic surgery that maintains stored parameter information relevant to the surgical procedure to be performed. The ophthalmic surgical instrumentation 200 also includes one or more processors and memory, which may include any suitable form of information-processing device and memory as described above and which may include image processor 150. The parameter information is communicated from the ophthalmic surgical instrumentation 200 to the image processor 150 in order to allow the display 130 to include parameter information from the surgical instrumentation 200. Examples of heads-up displays with user-selectable, non-overlapping sectors are described in detail in co-pending U.S. patent application Ser. No. 13/086,509, which is incorporated herein by reference. The heads-up display 130 may include, for example, a variety of phacoemulsification and/or vitrectomy surgical parameters, including but not limited to power level, vacuum pressure for phacoemulsification, bottle height for irrigation solution, aspiration, footswitch position, phacoemulsification step and occlusion indicator, or ophthalmic laser surgery parameters, such as power level or standby status.

The heads-up display 130 refers to any display including operating parameters from the surgical instrumentation 200. The heads-up display 130 is adapted for presentation in the 3-D image. Specifically, the heads-up display 130 is adjustable in a three-dimensional field of view of the 3-D image by means of a user interface 170 of the surgical system 100, which may be any suitable device for receiving information from a user of the surgical system 170, including but not limited to a keyboard, keypad, joystick, or mouse. The user can be, for example, a surgeon, a field service technician, or a factory technician. For purposes of this specification, “adjustable in a three-dimensional field of view” refers to the display 130 being able to alter the display properties in a way that changes the three-dimensional perception of the display relative to the image without changing the content of the display 130. Thus, for example, different portions of the display 130 may be displayed to different eyes. In another example, the display 130 could have an adjustable apparent depth within the three-dimensional image. In yet another example, the display could actually be projected onto a three-dimensional structure of the eye itself, using a device such as a laser projector, so that the location of the display relative to the eye can be directly adjusted. In alternative embodiments, the three-dimensional view of the display 130 may be automatically adjustable based on depth information received from a diagnostic device that is activated by the user.

Particular features of the three-dimensional heads-up display may have advantageous applications in specific ophthalmic surgical procedures. In one example, the increased depth perception may be useful in retinal procedures such as neovascularization for advanced macular degeneration. It may also allow easier visualization of sub-retinal fluid. The visualization of ultraviolet light could allow three-dimensional perception of cataracts or posterior capsule opacification using UV-scattering from those structures. Infrared radiation could be used to see through structures that are opaque to visible light, such as when retinal surgery is performed on a patient with a cataractous lens, and to visualize structures like the choroid that have unique thermal signatures. Similar techniques could be used to visualize the progress of surgical techniques such as photocoagulation that change the tissue's optical and/or thermal properties.

The use of a 3-D camera 110 may also allow pulsed-probe imaging by varying the capture rate and/or shutter speed for imaging. This can be particularly useful in fluorescent light diagnostics such as fluroscein and indocyanine green (FA/ICG) angiography, where the excitation pulses and the emission pulse might both be visible. By timing the excitation (probe) light with the shutter, the resulting image can ignore the excitation pulse and display only the emitted (characterizing) pulse. Similar techniques could be used in Raman spectroscopy to detect the progress of drugs in the ocular system. More generally, the wavelength sensitivity of the 3-D camera can be adjusted as noted previously, so that specific wavelengths can be viewed or enhanced as desired.

More generally, the use of 3-D digital imaging allows the information to be stored, recorded, or transmitted, including the heads-up display 130, so that observers can easily benefit from the ability to view the surgical operation. This can be used for educational purposes, for enabling post-processing and analysis, and remote consultation and telemedicine. Numerous other advantages of digital information storage will also be readily apparent to one skilled in the art.

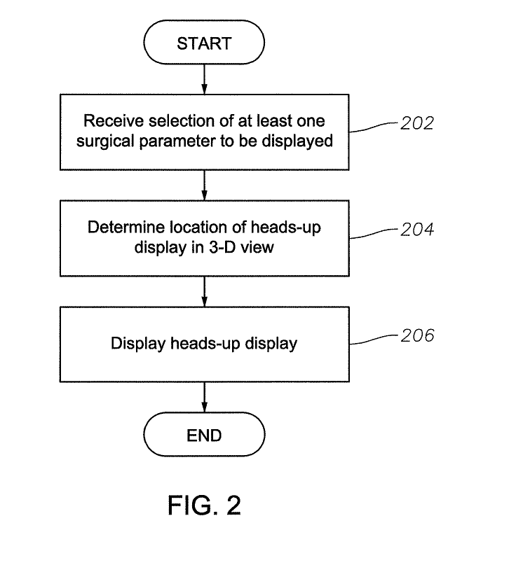

FIG. 2 is a flow chart 200 illustrating an example embodiment of a method of generating a heads-up display for an ophthalmic surgical system. At step 202, the method includes receiving a selection of at least one surgical parameter to be displayed. At step 204, the method further includes determining a location of a heads-up display in a three-dimensional view of a three-dimensional image of a patient's eye. The location of the heads-up display in the three-dimensional view is adjustable based on at least one user selection. At step 206, the method includes displaying the heads-up display in the three-dimensional image of the patient's eye.

Embodiments described above illustrate but do not limit the invention. It should also be understood that numerous modifications and variations are possible in accordance with the principles of the present invention. Accordingly, the scope of the invention is defined only by the following claims.

What is claimed is:

1. An ophthalmic surgical system, comprising:
a three-dimensional imaging device operable to display a three-dimensional image of a patient's eye;
a display device including an image processor operable to generate a heads-up display of user-selectable surgical parameters on the three-dimensional image of the patient's eye, wherein the heads-up display is adjustable in a three-dimensional field of view of the three-dimensional image; and
a user interface operable to receive a user selection of one or more of the user-selectable surgical parameters to be displayed.

2. The ophthalmic surgical system of claim 1, wherein an apparent depth of the heads-up display in the three-dimensional field of view is adjustable.

3. The ophthalmic surgical system of claim 2, wherein the apparent depth is automatically adjustable based on information from a diagnostic device activated by a user.

4. The ophthalmic surgical system of claim 1, wherein the heads-up display comprises a first left-eye portion displaying a view for a left eye of a user and a second right-eye portion displaying a view for a right eye of the user.

5. The ophthalmic surgical system of claim 1, wherein the heads-up display is physically projected onto the patient's eye, and a location of the heads-up display on the patient's eye is adjustable.

6. The ophthalmic surgical system of claim 1, wherein the image processor is operable to generate a visible display of an invisible wavelength.

7. The ophthalmic surgical system of claim 6, wherein the invisible wavelength is an infrared wavelength.

8. The ophthalmic surgical system of claim 6, wherein the invisible wavelength is an ultraviolet wavelength.

9. The ophthalmic surgical system of claim 1, wherein the image processor is operable to generate a visual element highlighting an anatomical structure of the patient's eye.

10. The ophthalmic surgical system of claim 9, wherein the anatomical structure is located in a retina of the patient's eye.

11. The ophthalmic surgical system of claim 1, wherein the three-dimensional image of the patient's eye displays a portion of the eye blocked by an intervening anatomical structure opaque to visible light.

12. The ophthalmic surgical system of claim 1, wherein the intervening anatomical structure is a cataractous lens.

13. The ophthalmic surgical system of claim 1, wherein the image processor filters out an excitation wavelength for a fluorescent material displayed in the three-dimensional image.

14. A method of generating a heads-up display for an ophthalmic surgical system, comprising:
receiving a selection of at least one surgical parameter to be displayed;
determining a location of a heads-up display in a three-dimensional view of a three-dimensional image of a patient's eye, wherein the location of the heads-up display in the three-dimensional view is adjustable based on at least one user selection; and
displaying the heads-up display in the three-dimensional image of the patient's eye.

15. The method of claim 14, wherein an apparent depth of the heads-up display in the three-dimensional field of view is adjustable.

16. The method of claim 15, wherein the apparent depth is automatically adjustable based on information from a diagnostic device activated by a user.

17. The method of claim 14, wherein the heads-up display comprises a first left-eye portion displaying a view for a left eye of a user and a second right-eye portion displaying a view for a right eye of the user.

18. The method of claim 14, wherein the heads-up display is physically projected onto the patient's eye, and a location of the heads-up display on the patient's eye is adjustable.
